(19) United States
(12) Patent Application Publication
(10) Pub. No.: US 2010/0031045 A1
(43) Pub. Date: Feb. 4, 2010

(54) METHODS AND SYSTEM AND COMPUTER MEDIUM FOR LOADING A SET OF KEYS

(76) Inventors: Lakshmi Narasimham Gade, Hyderabad (IN); Rajanarasiah Soma, Hyderabad (IN)

Correspondence Address: Linkwell Telesystem (P) Ltd., 1-11-252/1/A, Gowra Klassic, Begumpet, Hyderabad, 500016, omitted

(21) Appl. No.: 12/272,819

(22) Filed: Nov. 18, 2008

(30) Foreign Application Priority Data
Jul. 30, 2008 (IN) 1819/CHE/2008

(51) Int. Cl. H04L 9/00

(52) U.S. Cl. 713/172; 713/150

(57) ABSTRACT

The present technique relates to a method for authenticating a user of at least one electronic terminal. The method includes receiving a first unique value for loading into the at least one electronic terminal via an input module. The method includes storing internally the first unique value for authorizing the user of the at least one electronic terminal using a memory module. The method generates a second unique value for saving internally into the memory module using a random process module. The method generates an encrypted third unique value and sending to a host by encrypting the second unique value using the first unique value.

### TECHNICAL FIELD OF THE INVENTION

The present technique relates generally to electronic terminals and devices for holding secured information for authorizing and authenticating users. In one aspect, the techniques relates to loading a set of keys into one or more electronic devices.

### BACKGROUND OF THE INVENTION

In various applications, methods based on dual control and split knowledge are currently provided in Secure Electronic Devices (SED) to enhance the security ambit for loading one or more encryption key(s) into a secure electronic device (SED).

In many applications, however, electronic PIN entry devices, secure payment terminals and access control devices that hold secret information such as a cryptographic key of an authorized person or entity which is crucial for the SED to perform secure processing and communication of sensitive information.

Conventional techniques, permits remote acquisition of ownership, loading key(s) into the SED and operational control of the SED in a process of cryptographically controlled secure sequence of operations between the SED and a SKL.

Accordingly, there is a need for a technique to load keys into one or more electronic devices.

### SUMMARY OF THE INVENTION

The present technique relates to a method for loading a set of keys into at least one electronic device. The method includes receiving a first unique value for loading into the at least one electronic device via an input module. The method includes storing internally the first unique value for authorizing the user of the at least one electronic device using a memory module. The method generates a second unique value for saving internally into the memory module using a random process module. The method generates an encrypted third unique value and sending to a host by encrypting the second unique value using the first unique value.

The method includes decrypting the encrypted third unique value from the at least one electronic device for utilizing in a network using the host. The method further includes selecting random text data for encryption and sending encrypted text data to the at least one electronic device using a fourth unique value. The method decrypts the encrypted text data to confirmation text data for verifying the text data using the first unique value and the second unique value. Furthermore, the method includes if the random text data is equal to the confirmation text data, loading the set of keys into the at least one electronic device.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a flowchart illustrating a process for loading a set of keys into one or more electronic devices, in accordance with an aspect of the present invention;

FIG. 2 is a block diagram depicting a system for loading a set of keys into one or more electronic devices, in accordance with an aspect of the present invention;

FIG. 3 is a block diagram depicting architecture of an electronic device, in accordance with an aspect of the present invention;

FIG. 4 is a flowchart illustrating a set-up process performed between a device, a manufacturer or an authority system and a key manager system, in accordance with an aspect of the present invention; and

FIG. 5 is a flowchart illustrating a set-up process performed between a device, an authority system and a key manager system, in accordance with an aspect of the present invention.

### DETAILED DESCRIPTION OF THE INVENTION

The present technique relates to a process of secure cryptographic key loading into an SED using an SKL, employing commonly known cryptographic operations and without involving a dual control and split knowledge at the SED. The basic terminologies of the present technique are as follows:
SKL Public Key—APK—first unique value
MAK—second unique value
SKL—Host
APK MAK—third unique value
SED Public key—fourth unique value
SED private key—fifth unique value
MAK (PTS)—first message
APK (MAK) (PTS)—second message
SED-Master Key—SMK—sixth unique value.
(SPK (MAK (SMK)))—third message.

A Secure Electronic Device (SED) is designed to be programmable to securely perform any or all such operations to acquire, store, display, modify, process and communicate secret information only with an Authorized Person who possesses the requisite cryptographic keys for control of the entire device or a distinct logical and functional sub-part of the device; and such secret information is reasonably protected from disclosure to unauthorized persons within adequately high limits of time, cost and effort expendable per SED towards planning and execution of attacks intended to obtain unauthorized disclosure of secret information from the SED. A Secure Key Loader (SKL) is a host computer or an SED programmable for secure cryptographic key loading operations with one or more SEDs that are logically accessible via a data communication link or an information network such as the Internet.

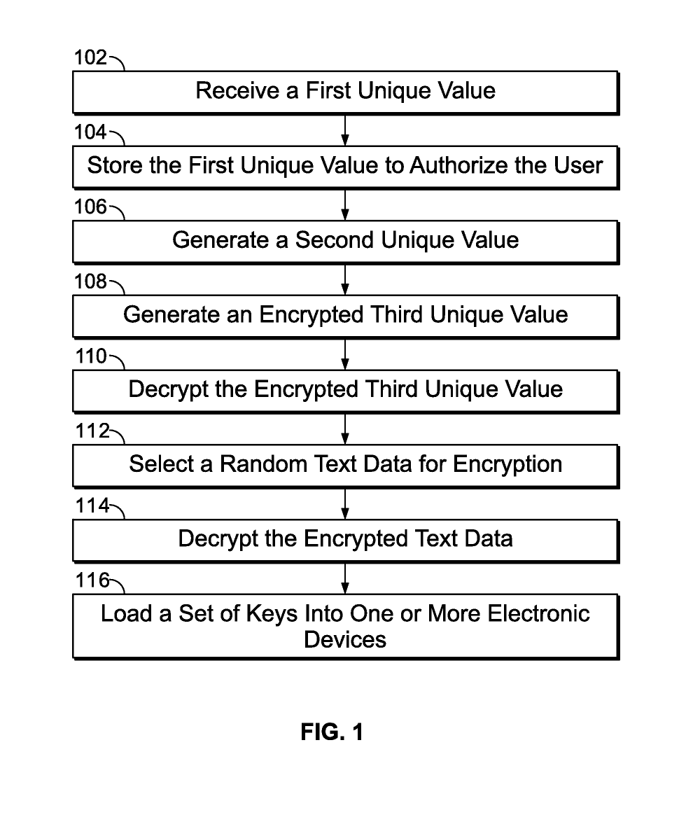

Referring to FIG. 1 is a flowchart illustrating a process for loading a set of keys into one or more electronic devices.

At block 102, a first unique value is received. Moreover, digital trust is established between the SED Manufacturing Security Officer (MSO) and the SED Acquirer (ACQ) wherein the ACQ and MSO exchange their Public Keys. In similarity, when the SED is switched ON for the first time in a virgin state, such as immediately after manufacture; or after a “factory reset” which restores the device to a virgin state where all secret information has been erased, one and only one SKL Public Key (APK) is permitted to be loaded into the SED by design whether it is via an electronic data communication link or manual entry by any keyboard or similar mechanisms provided in the SED by design. Similarly, the methods of generating the APK by the SKL are also many, and also includes of use the Dual Control and Split Knowledge criterion if SKL domain trust relationships require it to be so in the generation of the APK.

At block 104, the first unique value to authorize the user is stored. The SED stores the APK internally and from that moment the person or entity who possesses the corresponding private key securely owns the SED. In addition, the SED generates a symmetric encryption key, such as a 3DES key, by means of a random process and saves it as a “Manufacture Assurance Key” (MAK) internally. Additionally, the SED encrypts the MAK using the APK thereby yielding an encrypted MAK represented herein as (APK (MAK)) for convenience.

At block 106, a second unique value is generated. The (APK (MAK)) is given out by the SED along with the Identification Number of the SED in response to a command issued to the SED. In addition, the SKL now commands the SED for issue of its SED Public Key (SPK). Similarly, the SED generates an RSA key pair and issues out an SED Public Key (SPK) to the SKL. In contrary, the SED may also issue out an SED identification string. Further, the SKL retrieves the (APK (MAK)) from the SED, uses the SKL Private Key within its secure and trusted environment to de-crypt and recover the MAK for further use in secure communications and cryptographic key loading operations with the SED.

At block 108, an encrypted third unique value is generated. In this application, the SKL chooses any random plain text string (PTS) of its choice, limited only by the specification of the SED, encrypts the string using the SPK thereby yielding an encrypted (for example, a cipher text) message (SPK (PTS)) and sends it to the SED. Alternatively, the SED uses its internally stored SED Private Key (SRK) to decrypt and recover within its secure boundaries the PTS.

At block 110, the encrypted third unique value is decrypted. In the illustrated application, the SED re-encrypts the PTS using the MAK thereby yielding a (MAK (PTS)) and further encrypts it using the APK which yields (APK (MAK (PTS))). In practice, the SED issues out the (APK (MAK (PTS))) to the SKL which then decrypts the cipher text using the APK and MAK in that order and verifies the PTS.

At block 112, as in the technique described below, a random text data for encryption is selected. In the embodiment illustrated, the SKL encrypts the secret information such as SED master key (SMK) and other keys with the MAK and further by SPK yielding (SPK (MAK (SMK))). As described below, the SED receives the double encrypted (SPK (MAK (SMK))) and recovers the SMK by decryption with SED Private Key and MAK in that order.

At block 114, the encrypted text data is decrypted. Specifically, the SED is now ready to perform secure operations with a secure host computer that is in possession of the shared secret, the SMK key. For this purpose, the key loading process is complete and optionally, the SED destroys the MAK, SPK and SRK.

At block 116, a set of keys are loaded into one or more electronic devices. Furthermore, automatic pseudo random creation of the MAK linked to the SED state transition into a Virgin state and the subsequent transition to an owned state by the first APK that is loaded into the SED. In addition, authentication of the device by means of verification of the MAK via the PTS handshake prior to key loading operations. Additionally, eliminating of the dual control and split knowledge requirement in the SED by use of an extra layer of asymmetric encryption to perform all key loading operations.

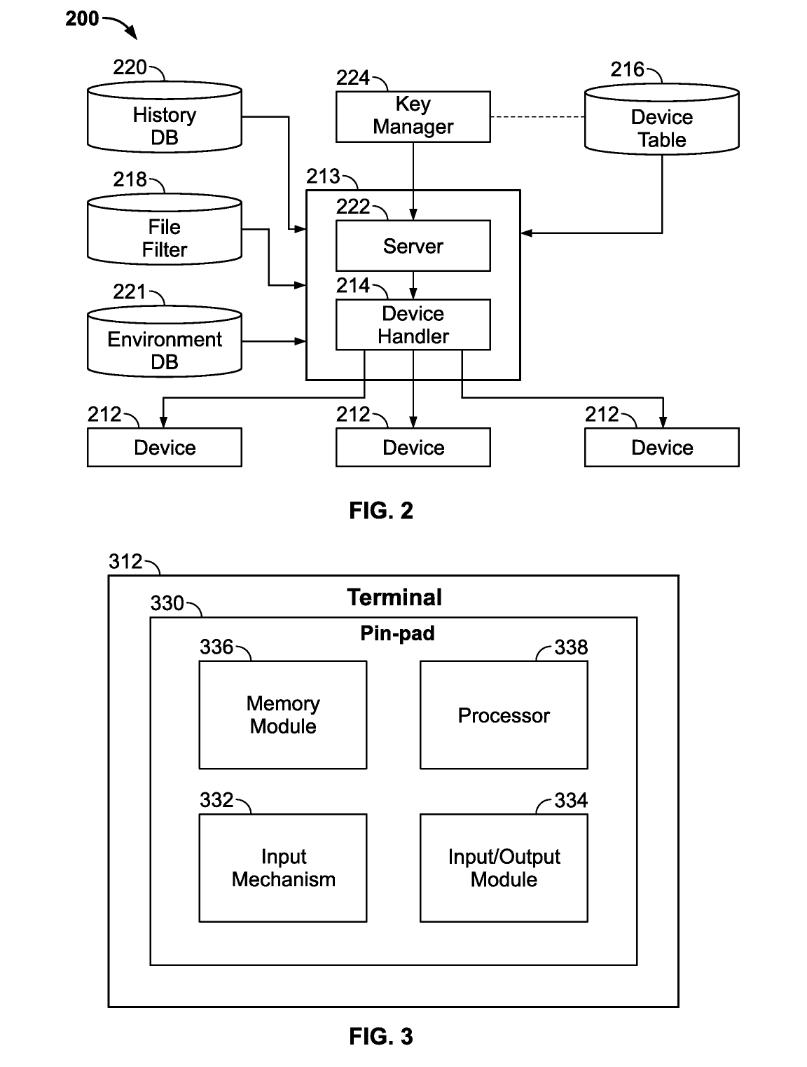

Referring to FIG. 2 is a block diagram depicting a system for loading a set of keys into one or more electronic devices. As shown in FIG. 2, the system 200 can include one or more electronic devices (hereinafter “devices”) 212, a host system or a terminal manager system 213, a device handler 214, a device table 216, a device file filter 218, an extract history database 220, an environment database 221, a server 222 and a key manager system 224. The system 200 can include more or fewer components than those shown in FIG. 2. In addition, the functionality of the components of the system 200 can be combined and distributed in configurations other than those shown in FIG. 2. For example, the system 200 can include fewer or additional devices 212. The system 200 may not include a separate device handler 214. In some embodiments, the functionality of the devices 212 and/or the server 222 in a single component of the system 200. The system 200 can also include more than one device handler 214. For example, each device 212 can be associated with a separate device handler. The functionality of the key manager system 224 and the terminal manager system 213 can be combined and distributed in other configurations than those illustrated and described.

In some embodiments, the devices 212 can be included in a network of devices. The devices 212 can also be included in multiple networks of terminals managed by the device manager system 213. A device 212 can include one or more electronically or electrically devices that provides an interface to the system 200.

Referring to FIG. 3 is a block diagram depicting architecture of an electronic device. FIG. 3 illustrates a device 212 according to one embodiment of the invention. As shown in FIG. 3, a device 212 can include a pin-pad 330. The pin-pad 330 can include an input mechanism 332, such as a keypad, a touch-screen, a card reader or the like that allows the user to enter personal data, such as a personal identification number (PIN). As shown in FIG. 3, the pin-pad 330 can also include an I/O module 334 that transmits entered data to other components of the device 212 and/or other components included in the system 200. In some embodiments, the pin-pad 330 can include a memory module 336 can store a key issued to a device 212. The memory module 336 can also store software executable with the processor 338. In some embodiments, the processor 338 executes software stored in the memory module 336 in order to encrypt data entered with the input mechanism 332 with a key stored in the memory module 336 before the data is transmitted by the I/O module 334.

In some embodiments, the pin-pad 330 provides tamper resistance, and any attempt illegally obtain access to the pin-pad 330 can destroy the key stored in the memory module 336 of the pin-pad 330. Once a key associated with a device 212 is destroyed, all subsequent transactions involving the device 212 can fail. The failure of transactions can alert a technician or device manager to reissue a key and reinstall or reset a pin-pad 330 of a device 212. The device table can include information associated with one or more device 212 that the key manager system 224 can interact with. In order to create the device table, the device manager system 213 can execute an extraction program. The extraction program can extract device information from one or more data sources, such as the environmental database 221. The database 221 can include configuration data for mapping definitions for the device manager system 213, such as where the database 221 is located. In addition, the database 221 can include a terminal file. The terminal file can provide information about the devices 212 managed with the device manager system 213. A third record type can indicate an override public key and an override private key associated with a client identifier of a terminal 212.

In some embodiments, network identifiers associated with a particular device 212 can be stored in the database 221. Each type of record may include a field specifying a protocol that a public key and private key are to be used with. In some embodiments, records included in the device file filter 218 can include fields of alphanumeric data separated by non-alphanumeric characters, such as one or more spaces, commas, semicolons, white spaces etc. Data extracted from each data source can be used to create and populate the device table 216. Data extracted and/or generated during the execution of the extracted program can also be stored in the database 221, the extract history database 220, and/or the device file filter 218. The database 220 can include information regarding when the extraction program was executed. In some embodiments, the device table 216 can be managed with the device manager system 213. The key manager 224 can access the terminal table 216 in order to obtain information regarding the terminals 212 managed by the device manager system 213. The server 322 can obtain key-loading dialog messages from the device handler 214 and can format the messages such that the key manager system 224 can accept and use the messages. The server 322 can also obtain key-loading dialog messages from the key manager system 224 and can route messages to one or more device 212 via the device handler 214. In some embodiments, cryptographic information included in the messages sent to and/or from key manager system 224 can be base-64 encoded. In some embodiments, the server 322 and/or the key manager system 224 can create output which can be stored and/or updated to the device manager system 213.

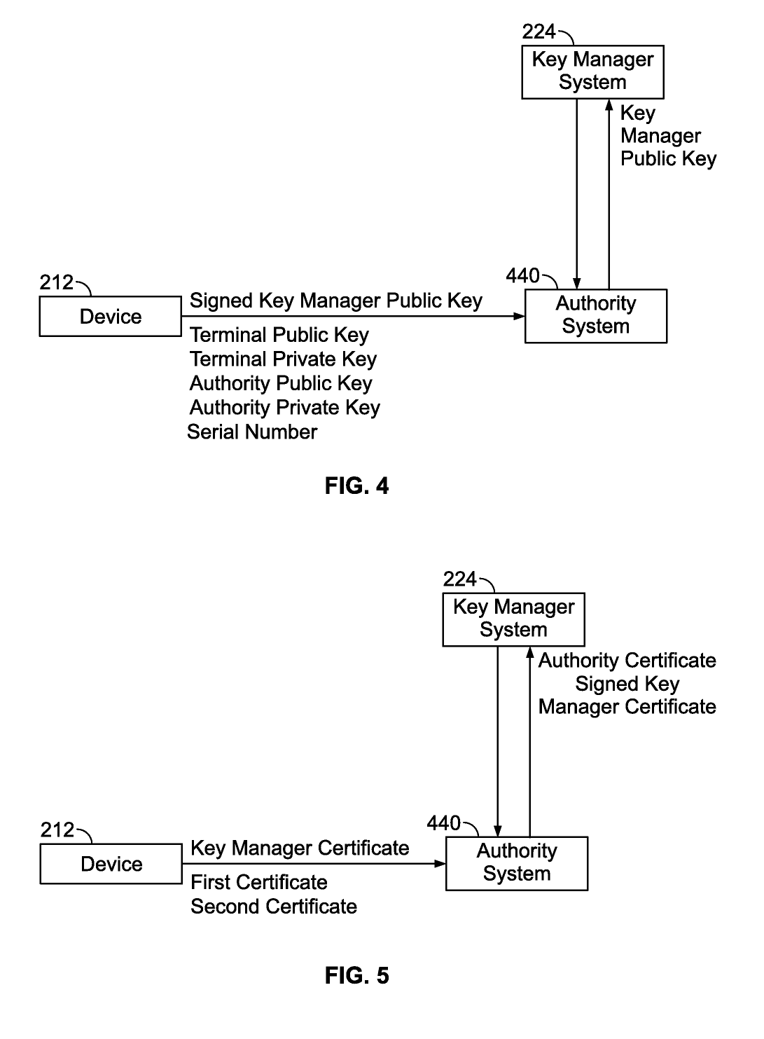

Referring to FIG. 4 is a flowchart illustrating a set-up process performed between a device 212, a manufacturer or authority system 440 and a key manager system 224 according to one embodiment of the present invention. The authority system 440 can send the device 212 a terminal public key, a terminal private key, an authority public and authority private key. The device 212 can use the terminal public key and the terminal the device manager system 213. The database 221 can include private key, the authority public and private keys to securely exchange information in a cryptographic system using public keys and private keys. Public private key cryptography systems use two keys to securely provide information to a receiver. A first key or a public key of the receiver can be provided to individuals who want to securely provide information to the receiver. Individuals with the public key can encrypt information for the receiver with the public key. A second key or a private key of the receiver is kept secret by the receiver and is used by the receiver to decrypt information encrypted with the public key of the receiver. Public keys and private keys are different keys and one key cannot be used to derive the other key. Thus, as long as a receiver can decrypt information encrypted with the receiver's public key.

In some embodiments the device 212 can generate the terminal public key and/or the terminal private key rather than receiving them from the system 440. The device 212 can include a serial number sent from the system 440. The serial number and terminal public key and the terminal private key can be unique for each device 212. The system 440 can send the key manager system 224 the authority public key. The system 224 can store the authority public key. The system 224 can send the authority system 440 a key manager public key. The authority system 440 can sign the key manager public key and can return the signed key manager public key to the key manager system 224. The key manager system can store the signed key manager public key. The system 224 can also store a key manager private key.

Signing a key includes encrypting a piece of information with a private key of a public key and a private key pair. Signed information can be authenticated as being sent from a particular individual, if a receiver of a signed data can decrypt the signed data using a corresponding public key of the individual. By a way of example, if a sender has a public key and a private key, and can provide the encrypted information to a receiver. The receiver can obtain the public key and can verify that the sender sent the encrypted information if the receiver can decrypt the encrypted information with the public key of the sender. Since only the sender knows the private key, if the receiver can decrypt the signed information with the corresponding public key, then only the sender could have created the signed information.

Referring to FIG. 5 is a flowchart illustrating a set-up process performed between a device 212, an authority system 440 and a key manager system 224 according to one embodiment of the present invention. The system 440 sends a terminal 212 a first certificate and a second certificate rather than the terminal public key, the terminal private key, authority public key and the authority private key.

Certificates include a public key signed by a trusted and authorized certificate provider. Certificates can include additional information, such as the name, address, etc of the individual associated with the public key included in the certificate.

The first certificate can include the terminal public key. The second certificate can include the authority public key. In some embodiments, the first certificate and /or the second certificate can include an identifier of the device 212. The first and the second certificate can be signed by the authority private key of the system 440 and/or another trusted certificate provider. The system 440 can send an authority certificate to the key manager system 224. The authority certificate can include the authority public key signed by a certificate provider. The public key of the certificate provider and the key manager system 224 can use the public key of the certificate provider to obtain the authority public key.

The system 224 can send a key manager certificate to the system 440. The key manager certificate can include the key manager public key, which can be signed by a certificate provider. The system 440 can sign the key manager certificate with the authority private key. The system 440 can send the signed key manager certificate to the key manager system 224.

The set-up processes shown in FIG. 4 and FIG. 5 include the key manager system 224 directly exchanging cryptographic information with the authority system 440.

The above description is intended to be illustrative, and not restrictive. Many other embodiments will be apparent to those skilled in the art. The scope of the invention should therefore be determined by the appended claims, along with the full scope of equivalents to which such claims are entitled. As will be appreciated by a person skilled in the art, the various implementations of the present technique provide a variety of advantages. The advantages of the present invention may be summarized as follows. Firstly, loading a set of keys into one or more electronic devices is enhanced with high security. Secondly, the process derived in the current invention makes possible secure remote ownership acquisition, authentication and control of an SED. Thirdly; the process can be applied for establishing cryptographically verifiable trust establishment covering the entire SED. Fourthly, automatic pseudo random creation of the MAK and authentication of the device by means of verification of the MAK via the PTS. Fifthly, eliminating of the dual control and split knowledge requirement in the SED by use of an extra layer of asymmetric encryption to perform all key loading operations.

While, the following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest cope consistent with the principles and features described herein.

Many modifications of the present invention will be apparent to those skilled in the arts to which the present invention applies. Further, it may be desirable to use some of the features of the present invention without the corresponding use of other features.

Accordingly, the foregoing description of the present invention should be considered as merely illustrative of the principles of the present invention and not in limitation thereof.

What is claimed is

1. A method for loading a set of keys into at least one electronic device, the method comprising:
receiving a first unique value for loading into the at least one electronic device via an input module;
storing internally the first unique value for authorizing the user of the at least one electronic device using a memory module;
generating a second unique value for saving internally into the memory module using a random process module;
generating an encrypted third unique value and sending to a host by encrypting the second unique value using the first unique value;
decrypting the encrypted third unique value from the at least one electronic device for utilizing in a network using the host;
selecting random text data for encryption and sending encrypted text data to the at least one electronic device using a fourth unique value;
decrypting the encrypted text data to confirmation text data for verifying the text data using the first unique value and the second unique value; and
if the random text data is equal to the confirmation text data, loading the set of keys into the at least one electronic device.

2. The method of claim 1, wherein loading the first unique value via the network or a keyboard entry or the like or the combination thereof.

3. The method of claim 1, wherein erasing text data of the at least one electronic device as switched on initially thereof.

4. The method of claim 1, further comprising issuing a command data to the at least one electronic device including a third unique value associated with an identification unique value.

5. The method of claim 4, wherein issuing the command data includes generating a fourth unique value by the at least one electronic device to the host.

6. The method of claim 1, further comprising decrypting and recovering from the at least one electronic device within the selected random text data by a fifth unique value.

7. The method of claim 1, further comprising generating a first message to the host by re-encrypting the random text data using the second unique value.

8. The method of claim 7, further comprising generating a second message to the host by encrypting the random text data using the first unique value.

9. The method of claim 8, further comprising issuing the second message to the host for verification of the text data by decrypting the first unique value and the second unique value.

10. The method of claim 1, further comprising generating a third message to the host by encrypting a sixth unique value.

11. A system for loading a set of keys into at least one electronic device, the system comprising:
an input module adapted to receive a first unique value for loading into the at least one electronic device;
a memory module adapted to store internally the first unique value for authorizing the user of the at least one electronic device;
a random process module adapted to generate a second unique value for saving internally into the memory module;
a host adapted to receive an encrypted third unique value by encrypting the second unique value using the first unique value; and
a network adapted to be utilized to decrypt the encrypted third unique value from the at least one electronic device using the host.

12. A tangible computer-readable medium having stored thereon computer executable instructions for a set of keys into at least one electronic device, the computer-readable medium comprising:
program code adapted for receiving a first unique value for loading into the at least one electronic terminal via an input module;
program code adapted for storing internally the first unique value for authorizing the user of the at least one electronic terminal using a memory module;
program code adapted for generating a second unique value for saving internally into the memory module using a random process module;
program code adapted for generating an encrypted third unique value and sending to a host by encrypting the second unique value using the first unique value;
program code adapted for decrypting the encrypted third unique value from the at least one electronic terminal for utilizing in a network using the host;
program code adapted for selecting random text data for encryption and sending encrypted text data to the at least one electronic terminal using a fourth unique value;
program code adapted for decrypting the encrypted text data to confirmation text data for verifying the text data using the first unique value and the second unique value; and
program code adapted for verifying if the random text data is equal to the confirmation text data, loading the set of keys into the at least one electronic device.

13. The computer-readable medium of claim 12, wherein loading the first unique value via the network or a keyboard entry or the like or the combination thereof.

14. The computer-readable medium of claim 12, wherein erasing text data of the at least one electronic device as switched on initially thereof.

15. The computer-readable medium of claim 12, further comprising issuing a command data to the at least one electronic device including a third unique value associated with an identification unique value.

16. The computer-readable medium of claim 15, wherein issuing the command data includes generating a fourth unique value by the at least one electronic device to the host.

17. The computer-readable medium of claim 12, further comprising decrypting and recovering from the at least one electronic device within the selected random text data by a fifth unique value.

18. The computer-readable medium of claim 12, further comprising generating a first message to the host by re-encrypting the random text data using the second unique value.

19. The computer-readable medium of claim 18, further comprising generating a second message to the host by encrypting the random text data using the first unique value.

20. The computer-readable medium of claim 19, further comprising issuing the second message to the host for verification of the text data by decrypting the first unique value and the second unique value.

21. The computer-readable medium of claim 12, further comprising generating a third message to the host by encrypting a sixth unique value.
